(19) United States
(12) Patent Application Publication
(10) Pub. No.: US 2009/0014037 A1
(43) Pub. Date: Jan. 15, 2009

(54) Method and Apparatus for Cleaning or Descaling of Thin Slabs and Strips in a Hot Strip Rolling Mill Train, Strip Treatment Installations or the Like

(76) Inventors: Hans-Peter Richter, Friedewald (DE); Heinrich Roese, Hilchenbach (DE); Stephan Kramer, Hilchenbach (DE); Walter Timmerbeul, Wuppertal (DE); Heinz-Dieter Gabriel, Neuss (DE); Juergen Seidel, Kreuztal (DE); Andreas Gramer, Solingen (DE)

Correspondence Address: ABELMAN, FRAYNE & SCHWAB, 666 THIRD AVENUE, 10TH FLOOR, NEW YORK, NY, 10017, US

(21) Appl. No.: 12/085,820

(22) PCT Filed: Nov. 17, 2006
(86) PCT No.: PCT/EP2006/011021

§ 371 Date: May 28, 2008

(30) Foreign Application Priority Data
Dec. 1, 2005 (DE) 10 2005 057 679.6
Apr. 27, 2006 (DE) 10 2006 019 544.2

(51) Int. Cl. B08B 3/04; B08B 13/00

(52) U.S. Cl. 134/42; 134/198

(57) ABSTRACT

The invention relates to a method of cleaning or descaling thin slabs and rolled strips in a hot strip rolling mill train and is characterized by use of cryogens such as oxygen or compound formed of cryogens with a carrier medium such as compressed air which are sprayed into slab surface or strip surface in liquid, deep-freeze form. The invention also relates to a method of cleaning and/or descaling of strips in a strip treatment installation with the above-mentioned characterized features, and to a correspondingly equipped apparatus.

The invention relates to a method of cleaning or descaling of thin slabs and strips in hot strip rolling mill trains, strip treatment installations or the like, and an apparatus for carrying out the method.

In a hot rolling process in hot strip rolling mill trains, the slab or the strip is subjected to a constant scaling during transportation through the furnace and the rolling mill train. The scale is removed, as a rule, with an aid of scale washers, before rolling is carried out. At that, water under high pressure (about 200 . . . 380 bar) is sprayed onto a hot surface. As a result of application of water, together with a desired cleaning process, a not unsubstantial cooling of the strip takes place. In rolling mill installations in which the casting machine is directly connected with a rolling mill train, i.e, the strip is rolled with the casting speed, this cooling effect is particularly damaging due to low transportation speeds.

In strip treatment installations, as a rule, the scale is removed in pickling lines before rolling is carried out. At that, the strip is pulled through a hot acid bath (hydrochloric acid, sulfuric acid, acid mixtures, etc.). As a result of chemical reactions, a desired cleaning process takes place. This process is nevertheless expensive and because of the used acid bath, is not absolutely environment-friendly.

German Patent DE 199 53 230 C2 discloses a cold rolling process in which in the region of the roll gap, instead of cooling liquid, an inert gas, which has an inert gas temperature which lies below a room temperature and is lower than the rolled stock temperature in the roll gap, is blown in, and WO 02/087803 discloses a method and an apparatus in which, as at cold rolling, an inert gas is fed in the vicinity of the roll gaps of the roll. However, the ratios of cold rolling cannot be transferred to hot rolling and surface treatment of strips.

Therefore, different alternatives were investigated for minimizing the temperature loss during hot rolling in descaling processes and for improving the cleaning effect and for improving the strip cleaning in the strip treatment installations.

As an advantageous solution of the problem, the use of cryogenics for cleaning or descaling processes for slabs or strips proved itself. Here, one has in mind liquid gases such as, e.g., liquid oxygen or carbon dioxide. The gases can be used in a pure form or with the use of compressed air or any other suitable carrier medium. The liquid gas is sprayed onto the slab and strip surface like water in the scale washer. However, because the liquid gas is handled, it evaporates as soon as it reaches the surface, and only a minimal temperature reduction occurs. The non-evaporated gas, together with dust and/or scale particles, if necessary, are finally aspirated. The cleaning action or the descaling action is based on three actions:
Thermal Action
   Microfissures are formed in the scale layer and between the scale and the strip
Kinetic Action
   The liquid particles appear on the surface and penetrate into the produced gaps.
Phase Transformation
   The sudden increase of volume of the liquid gas pounces on the scale layer or dirt layer.
   This process provides the following advantages during hot rolling in a hot strip rolling mill train:
      Removal of scale
      Smaller temperature loss during surface cleaning
      The smaller temperature loss can be used for:
         Saving of heating energy, as a lower furnace temperature can be selected.
         Reduction of the thickness of the finished strip at an adequate end rolling temperature
         Expansion of the configuration of the installation (combined casting-rolling process).
         Elimination of conventional scale washers with a corresponding supply of pressurized water and thereby, further energy saving.
         A lower temperature stability over the strip width is required.
         In addition to the descaling action, the region of the strip, in the vicinity of the application areas, is surrounded by inert gas (gas is distributed). There, new scaling is prevented.

With this process, the following advantages are obtained in strip treatment installations:
Removal of scale
Smaller consumption of acid during pickling
Smaller energy consumption during pickling
Shortening of pickling vessels or elimination of one or more pickling stages
Efficiency increase at an alternative descaling process
Increase of productivity of the available pickling lines
Oxygen descaling as a substitute for a straightening device (scale breaker, i.e., elimination of the straightening device (scale breaker).

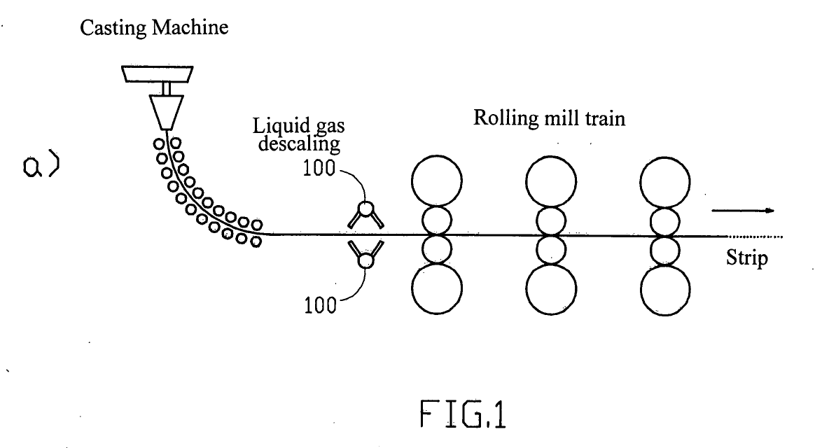

FIGS. 1 through 6 show possible mounting locations for a descaling apparatus with liquid gas in a strip hot rolling mill train:

FIG. 1 shows an installation behind a casting machine in front of a rolling mill train or a furnace. Here, the transportation speed is particularly low. Here, a conventional descaling is difficult to realize;

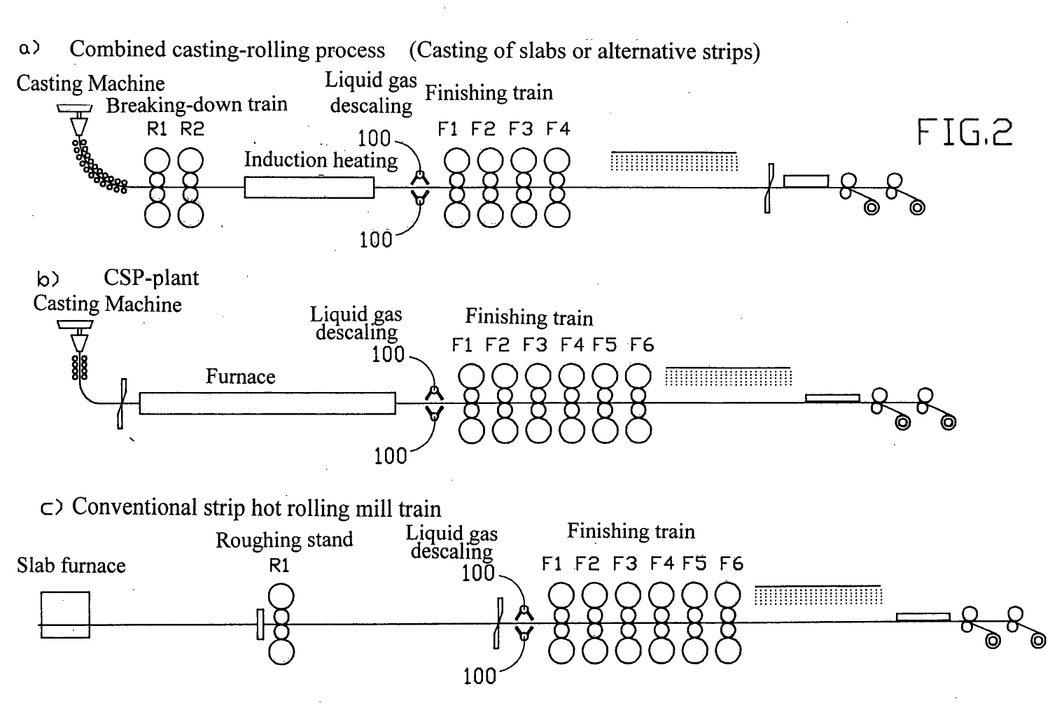

FIG. 2 shows a possible mounting location in front of a finishing rolling mill train;

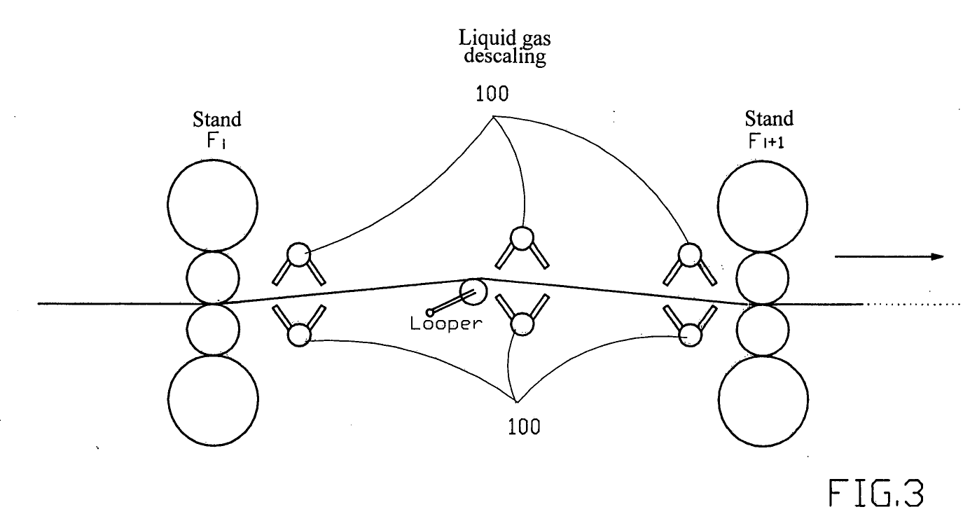

FIG. 3 shows uses between two rolling mill stands of a finishing rolling mill train. By removal of a thin scale layer, the rolling-in reduces the newly formed secondary scale. In order to prevent a certain scale thickness of the finished strip (coil), with the object to increase the pickling speed, a liquid gas descaling is contemplated shortly before the pinch rollers/reel, as

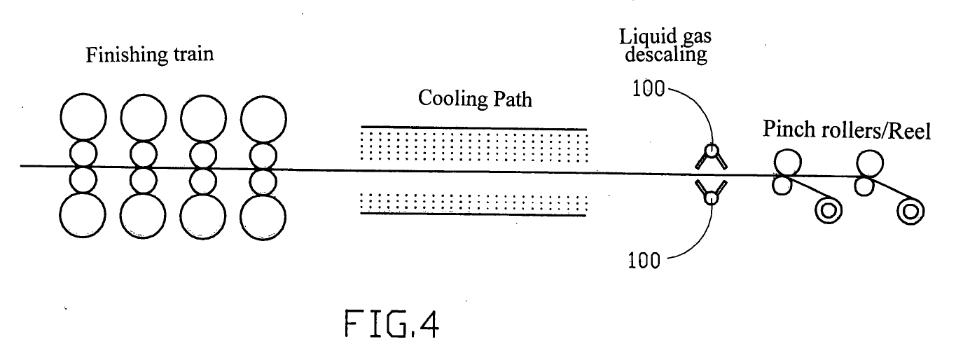

FIG. 4 shows.

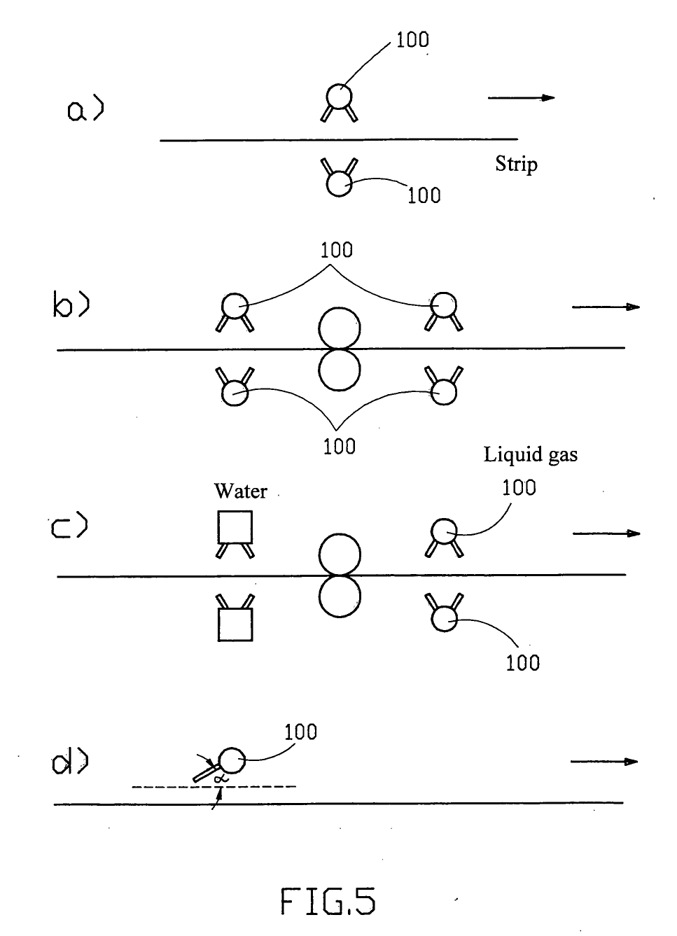

FIG. 5 shows that liquid gas cleaning can be carried out with a separate apparatus with one or several spray booms or in combination with a conventional descaling or low-pressure strip cleaning can be effected; and

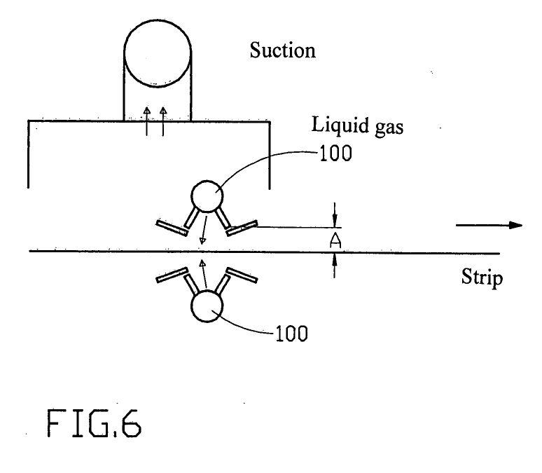

FIG. 6 shows how suction of gases or scale particles can be carried out. FIG. 6 further shows the effected screening of the distribution conduit in front of the hot band. It can further be seen that the nozzle is positioned as close in front of the strip as possible to obtain a complete effect so that the liquid would reach the surface before it evaporates.

Possible mounting locations for a descaling apparatus with liquid gas in a strip treatment installation are:
1. An arrangement as a compliment of a straightening device, i.e., the nozzles are mounted in or directly on the straightening device. This mounting location is suitable also for modernization purposes when the suction apparatuses are already installed.
2. A descaling apparatus with liquid gas as “stand alone” use, eventually as a substitute for a straightening device.

1-11. (canceled)

12. A method of descaling of thin slabs in a hot strip rolling mill train or strips in a strip treatment installation by spraying a liquid gas onto a to-be descaled surface of the strip slabs or strips,
characterized in that
the liquid gas is a mixture of cryogens with a carrier medium such as compressed air; and that a liquefied cryogen, if necessary, together with the carrier medium and scale particles are aspirated from the thin slabs or strips.

13. An apparatus for carrying out the method of claim 1, comprising one or more spray booms for spraying a liquid gas on an upper or lower side of thin slabs or strips,
characterized in that
the liquid gas is a mixture of cryogens with a carrier medium such as compressed air, and that a suction device is provided for aspirating the gas and scale particles.
